(19) United States
(12) Patent Application Publication
(10) Pub. No.: US 2012/0073901 A1
(43) Pub. Date: Mar. 29, 2012

(54) Passenger Or Load Raising Aid

(75) Inventor: Olav Virus-Tetzlaff, Havixbeck (DE)

(73) Assignee: GORACON ENGINEERING GMBH, Steinfurt (DE)

(21) Appl. No.: 13/140,838

(22) PCT Filed: Jun. 8, 2010
(86) PCT No.: PCT/EP2010/003416

§ 371 Date: Jun. 19, 2011

(30) Foreign Application Priority Data
Jun. 17, 2009 (DE) 10 2009 025 628.8

(51) Int. Cl. E06C 7/18

(52) U.S. Cl. 182/3

(57) ABSTRACT

The invention relates to a passenger or load raising aid for ladders (2), ascending ramps, or similar ascending devices, having a lift element (3) that can, for example, be driven by a motorized drive, particularly implemented as an endless cable, that can be connected to a belt system (5) that can be fastened to the person (1) or the load, and having a safety device attached to the belt system (5), implemented, for example, as a fall protection runner (10), secured to the ascending device (2). In order to implement a safe fall protection, the lift element (3) can be decoupled from the belt system (5) depending on the load.

The invention concerns a person or load raising aid for fixed ladders, climbing ramps or similar climbing devices, comprising a pulling element that is, for example, drivable by means of a motoric drive and is in particular embodied as an endless cable and can be connected to a belt system to be secured on the person or the load, and comprising a safety device that is secured to the belt system and is embodied, for example, as a fall arrest slide and is secured on the climbing device.

Person or load climb assist devices of the aforementioned kind are known and serve in particular for weight relief of a person that climbs on a fixed ladder, for example, on a building, in order to overcome great heights by doing so. This is, for example, to be provided on smokestacks, wind turbines, and similar facilities. The motoric drive is usually embodied in the form of a cable winch that relieves the person or the load to be transported with a predetermined pulling force during the ascent.

In this connection, in case of conventional person or load climb assist devices, a pulling cable arranged about deflecting pulleys on a fixed ladder is provided that by means of a cable clamp can be connected to an eyelet provided on the belt system. For securing the person or the load, preferably a fall arrest system is provided that is also connected by means of an eyelet to the belt system and engages a rail on the climbing device and in particular serves for securing a person or a load in case of a fall. In case of a fall, the person or the load is therefore suspended from the fall arrest system and the pulling element; however, in practice this does not provide a satisfactory fall protection.

It is therefore an object of the invention to provide a person or load climb assist for a climbing device that, in case of a fall, secures the person or the load secured to the belt system in a way appropriate for practical use.

As a solution to this object the person or load climb assist of the aforementioned kind is characterized in that the pulling element can be decoupled. load-dependent, from the belt system.

In this way, a person or load climb assist is made available with which, load-dependent, and thus in particular also in case of a fall where a person no longer is supported on the fixed ladder itself and therefore a corresponding great load is acting on the pulling element, the pulling element is automatically decoupled so that the person or the load is to be secured solely by the safety device on the climbing device. In this way, the pulling element for these securing actions can no longer have an effect on the safety device and therefore can no longer impair it so that the safety device is to be designed concretely for these fall protection tasks.

The safety device itself can be connected, as is conventional, to the fixed ladder, for example, by means of a rail. The connection with the belt system for the climbing person or the ascending load is however designed such that it has a separation site that, in case of a fall, but also in case of an overload situation, decouples the connection between the pulling element and the belt system. The connection between the pulling element and the belt system can be embodied by various components with different separating sites. Especially preferred is a connection between the pulling element and belt system that comprises a separable magnet connection wherein the magnetic force is adjusted such that for usual body weight forces the magnet connection will separate so that the appropriate separation of the two magnet parts can be realized. During normal ascent where the belt system has to carry also increased body weight forces, the safety device will not release at the separation location. The release force situation is adjustable.

However, alternative connections for realization of this separation site can be provided also, for example, in the form of an adhesive connection, in the form of a tear-off shock absorbing lanyard, in the form of a shear bolt, in the form of couplings, clamps or the like. Important is that in case of a fall the pulling element is separated or decoupled from the belt system for the ascending person or the load being raised.

For further explaining the invention, reference is being had to the further description and the drawing. The drawing shows in:

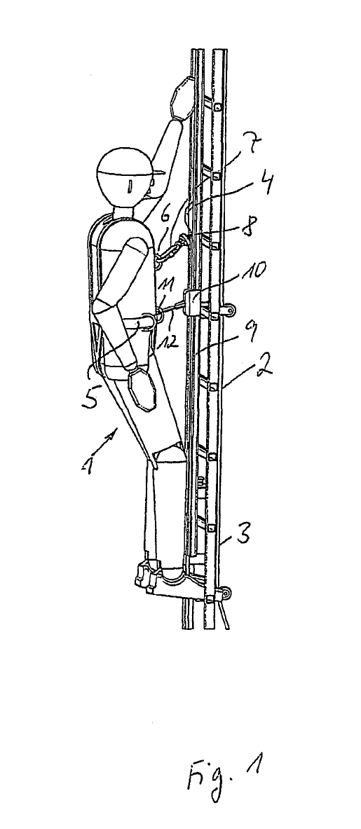

FIG. 1 one embodiment of a climb assist for a person in a perspective illustration (detail view) in the coupled state of the pulling element;

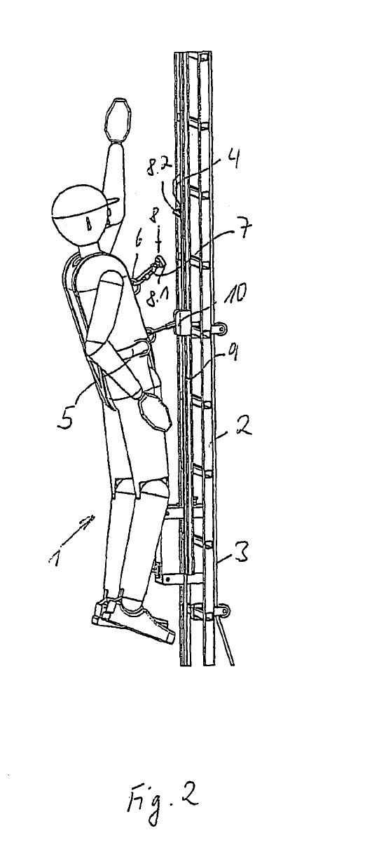

FIG. 2 an illustration analog to FIG. 1 of the embodiment of FIG. 1 in case of a fall and thus in decoupled state of the pulling element;

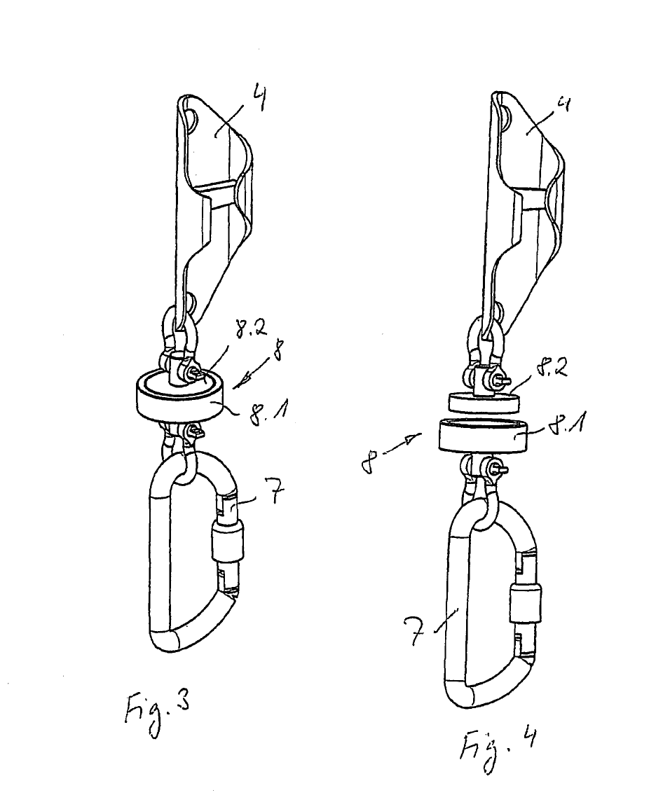

FIG. 3 an embodiment of a connection between the pulling element and the connecting part of a belt system in the form of a magnet connection in the coupled state; and

FIG. 4 an illustration analog to FIG. 3 in the decoupled state of the magnet connection.

Principally, parts that are acting in the same way are provided with same reference characters in the drawing. A climbing person on a fixed ladder 2 is generally identified by 1. On the fixed ladder 2, a cable winch, not illustrated in detail, with endless cable 3 as a pulling element is provided; at the upper area of the fixed ladder it is guided about a deflection pulley, not illustrated. By means of a clamping element 4 the belt system 5 is connected to the pulling cable 3. To the belt system 5 an eyelet 6 as well as a snap hook 7 are connected; the snap hook is to be connected to the pulling element 3 by a connecting element, referenced generally by 8, that can be decoupled, dependent on the load, from the belt system 5.

In addition, a rail 9 is provided on the fixed ladder 2 on which a fall arrest slide 10 is movably guided. This fall arrest slide 10 comprise a clamping element, not visible, in order to secure the person 1 in a fixed position on the fixed ladder 2 in case of a fall. For connection, an eyelet 11 is also provided on the belt system 5 as well as a connecting part 12.

In FIG. 1 the climbing person 1 is connected to the fall arrest slide 10 as well as the pulling element 3. Since the person is ascending, the connecting element 8 is coupled because, as a result of the climbing process, the entire weight of the body is not suspended from the connecting element 8.

This is different in the embodiment according to FIG. 2. Here it is illustrated that the person has lost contact with his feet with the fixed ladder and is falling. Accordingly, the connecting element 8 with its connecting parts 8.1 and 8.2 that represent a magnet connection (see also FIGS. 3 and 4) is decoupled. Between the connecting parts 8.1 and 8.2, the separation site of the connecting element 8 is therefore realized.

In enlarged illustration, in FIGS. 3 and 4 the clamping part 4 for pulling element 3, the magnet connection 8 with the connecting parts 8.1 and 8.2, and the snap hook 7 for connecting to the eyelet 6 of the belt system 5 are shown in more detail. In the illustration according to FIG. 3 the magnet connection is closed, i.e., coupled, while the illustration according to FIG. 4 shows the connecting parts 8.2 and 8.1 of the magnet connection 8 being decoupled as a result of increased weight.

What is claimed is:

1.-9. (canceled)

10. A climb assist for a climbing device, the climb assist comprising:
a driven pulling element;
a belt system to be secured on a person climbing on the climbing device or a load to be raised on the climbing device;
a safety device secured to the climbing device and to the be system;
wherein the pulling element is connected to the belt system by a connection provided with a load-dependent decoupling action.

11. The climb assist according to claim 10, wherein the driven pulling element is an endless driven cable.

12. The climb assist according to claim 10, wherein the safety device is a fall arrest slide.

13. The climb assist according to claim 10, wherein the connection between the pulling element and the belt system comprises a connecting element that has a separation site providing the load-dependent decoupling action.

14. The climb assist according to claim 10, wherein the safety device comprises a connecting snap hook.

15. The climb assist according to claim 10, wherein the load-dependent decoupling action is an adhesive connection.

16. The climb assist according to claim 10, wherein the load-dependent decoupling action is a shock absorbing lanyard with a tear-off seam connection.

17. The climb assist according to claim 10, wherein the load-dependent decoupling action comprises a shear bolt.

18. The climb assist according to claim 10, wherein the load-dependent decoupling action is a connection comprising couplings or clamps.

19. The climb assist according to claim 10, wherein the load-dependent decoupling action is a separable magnet connection.

20. The climb assist according to claim 10, wherein the load-dependent decoupling action comprises one or more connections selected from a tight hook-and-loop connection, a vacuum connection, a shrink-fit hose connection, and a connection comprising a break-off bolt connection.
